(19) United States
(12) Patent Application Publication
(10) Pub. No.: US 2014/0063240 A1
(43) Pub. Date: Mar. 6, 2014

(54) SYSTEMS, APPARATUSES, AND METHODS FOR BRANDING AND/OR ADVERTISING THROUGH IMMEDIATE USER INTERACTION, SOCIAL NETWORKING, AND IMAGE SHARING

(71) Applicants: Joseph Matthews, Chicago, IL (US); Jonathan P. Treble, Chicago, IL (US)

(72) Inventors: Joseph Matthews, Chicago, IL (US); Jonathan P. Treble, Chicago, IL (US)

(21) Appl. No.: 13/933,638

(22) Filed: Jul. 2, 2013

Related U.S. Application Data
(60) Provisional application No. 61/667,332, filed on Jul. 2, 2012.
(60) Provisional application No. 61/813,104, filed on Apr. 17, 2013.

(51) Int. Cl. G06Q 30/02; G06Q 50/00; G06K 9/00

(52) U.S. Cl. CPC G06Q 30/0276; G06K 9/00671; G06Q 50/01
USPC 348/143

(57) ABSTRACT

A computer-implement system, apparatus, and method for image collection, modification, and sharing. Images are transferred from a capturing device to a processing device, which modifies the image with information that may relate to the event at which the original image was taken and/or with information associated with at least one of a product, an entity that produces the product, or a third party organizing the event. Sharing the modified image may include sending it over a network means to a website, sending it over a network to nearby communication devices, and sending it directly to other devices.

### CROSS REFERENCE TO RELATED APPLICATIONS

This application claims priority to U.S. Application Ser. No. 61/667,332, filed Jul. 2, 2012, which is incorporated herein by reference in its entirety, and this application also claims priority to U.S. Application Ser. No. 61/813,104, filed Apr. 17, 2013, which is incorporated herein by reference in its entirety.

### FIELD OF THE INVENTION

The present invention generally relates to branding and advertising using various technologies and, more particularly, to systems, apparatuses, and methods for branding and advertising by immediate interaction with users and use of the users' social networking and image sharing sites.

### SUMMARY OF THE INVENTION

In one example, a system is provided for branding products and entities associated with the product.

In another example, a method is provided for branding products and entities associated with the product.

In a further example, a system is provided and includes an image capture device adapted to capture an image at an event and an image processing device adapted to receive the captured image and modify the captured image to include information associated with at least one of a product, an entity that produces the product, and a third party who organizes the event. The image processing device is adapted to communicate with social networking and/or image sharing sites to share the modified image.

### BRIEF DESCRIPTION OF THE DRAWINGS

So that those having ordinary skill in the art, to which the present invention pertains, will more readily understand how to employ the novel system and methods of the present invention, certain exemplary illustrated embodiments thereof will be described in detail herein-below with reference to the drawings, wherein:

FIG. 1 is a diagram of a portion of an exemplary system of the present invention;

FIG. 1A is a diagram of a remainder of the exemplary system illustrated in FIG. 1 with the combination of FIGS. 1 and 1A representing the entire exemplary system;

FIG. 2 is a flowchart of an exemplary process associated with the exemplary system shown in FIGS. 1 and 1A; and

FIG. 3 is an exemplary embodiment wherein image capturing device and image processing device are simultaneously connected to an elevation rod.

A component or a feature that is common to more than one drawing is indicated with the same reference number in each of the drawings.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

The present disclosure is directed to systems and methods for branding and/or advertising one or more products through modifying captured images and sharing modified images through social networking and/or image sharing sites, as detailed in the below exemplary embodiments. It is to be appreciated the subject invention is described below more fully with reference to the accompanying drawings, in which an exemplary illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for any claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in any appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that certain aspects of the embodiments of this invention as discussed below may be a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by any appended claims. All publications and references cited herein are expressly incorporated herein by reference in their entirety.

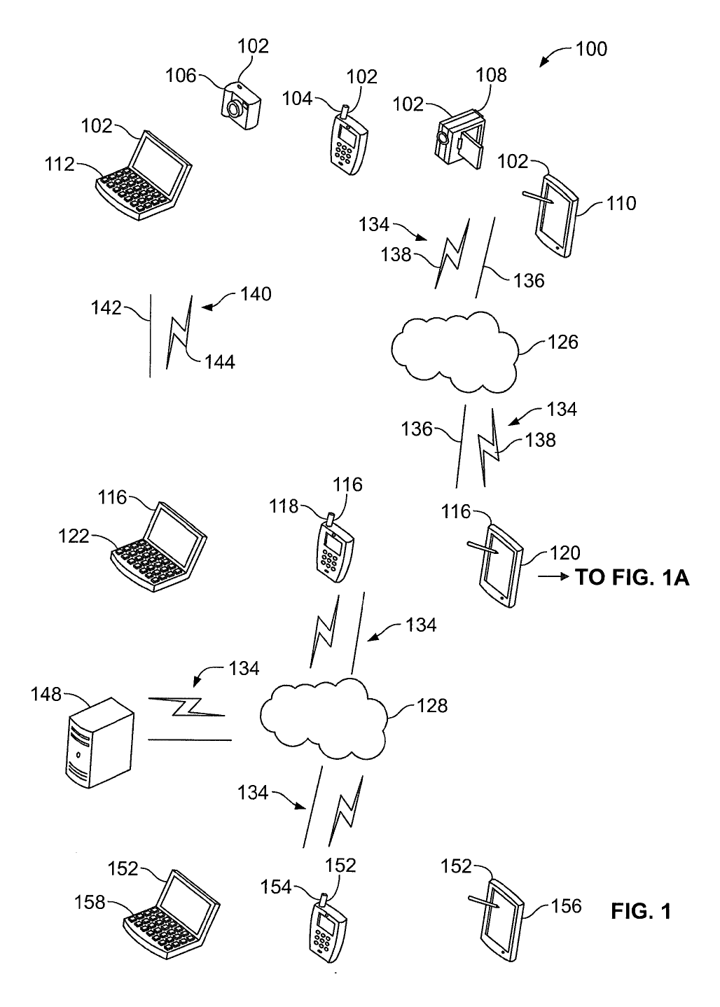

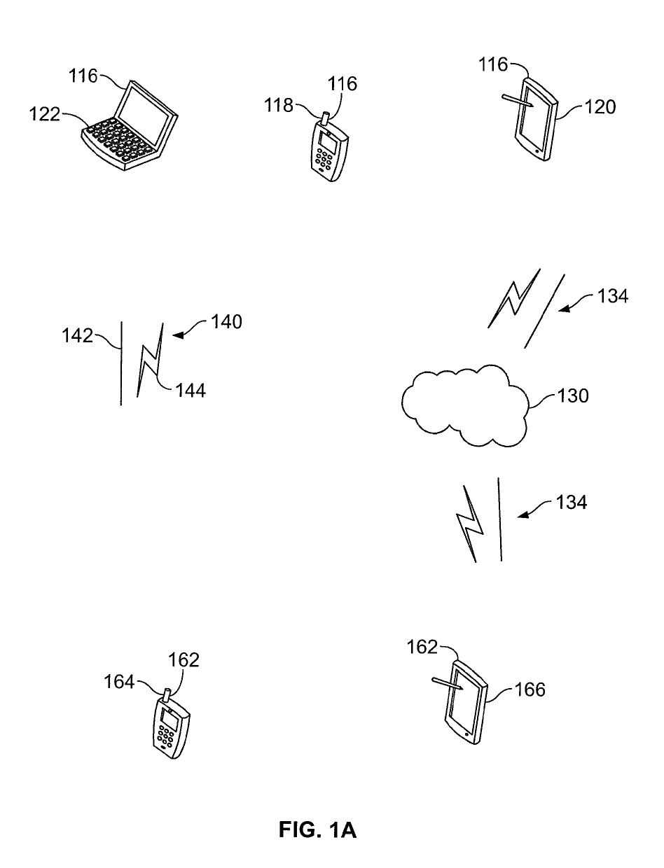

Referring to FIGS. 1 and 1A, an exemplary hardware diagram depicting a system 100 in which the processes described herein can be executed is provided for exemplary purposes. In one example, system 100 includes at least one instance of an image capture device 102. Exemplary embodiments of image capture device 102 include, but are not limited to, multifunction “smart phone” 104 including an image capture capability, such as a digital camera. In another example, the image capture device 102 could be a stand alone digital camera 106. In another example, the image capture device 102 could be a standalone video camera (e.g. webcam) 108. In another example, an image capture device 102 could be connected (e.g. wireless or wired) to a computing device, such as a tablet 110 or notebook 112 computer. The image captured by the image capture devices 102 may be a digital picture or photo, a digital video clip, or any other type of captured image.

It should be understood that image capture devices 102 each generally include at least one processor, at least one interface, and at least one memory device coupled via buses. Image capture devices 102 may be capable of being coupled together, coupled to peripheral devices, and input/output devices. Image capture devices 102 are represented in the drawings as standalone devices, but are not limited to such. Each can be coupled to other devices in a distributed processing environment.

It should further be noted that each image capture device 102 may include or be coupled to input devices, such as keyboards, speech recognition systems, mouses, trackballs, joysticks, etc. It is also understood that image capture devices 102 may include or be coupled to output devices, such as speakers, display devices and so forth to allow users to receive output of the processes described herein. Further, image capture devices 102 may be connected to various peripheral devices.

The system 100 also includes at least one instance of an image processing device 116. Exemplary embodiments of image processing device 116 include, but are not limited to, multifunction “smart phone” 118 and a computing device, such as a tablet 120 or notebook 122 computer.

It should be understood that image processing devices 116 each generally include at least one processor, at least one interface, and at least one memory device coupled via buses. Image processing devices 116 may be capable of being coupled together, coupled to peripheral devices, and input/output devices. Image processing devices 116 are represented in the drawings as standalone devices, but are not limited to such. Each can be coupled to other devices in a distributed processing environment.

It should further be noted that each image processing device 116 may include or be coupled to input devices, such as keyboards, speech recognition systems, mouses, trackballs, joysticks, etc. It is also understood that image processing devices 116 may include or be coupled to output devices, such as speakers, display devices and so forth to allow users to receive output of the processes described herein. Further, image processing devices 116 may be connected to various peripheral devices.

The image processing device 116 also includes an exemplary image processing engine for processing images in accordance with the functionality described herein. The image processing engine comprises hardware and/or software components programmed to perform image processing as further set forth herein. Image processing engine may contain instructions for controlling the processor to execute the methods described herein. Examples of these methods are explained in further detail in the subsequent exemplary embodiments section-below. The term “engine” is used herein to denote a functional operation that may be embodied either as a stand-alone component or as an integrated configuration of a plurality of subordinate components. Thus, image processing engine may be implemented as a single module or as a plurality of modules that operate in cooperation with one another. Moreover, although the imaging processing engine is described herein as being implemented as software, it could be implemented in any of hardware (e.g., electronic circuitry), firmware, software, or a combination thereof

The image capture devices 102 and image processing devices 116 all include memory and processors. The memory is a computer-readable medium encoded with a computer program. Memory stores data and instructions that are readable and executable by the processor of the respective device for controlling the operation of the processor. The memory may be implemented in a random access memory (RAM), volatile or non-volatile memory, solid state storage devices, magnetic devices, a hard drive, a read only memory (ROM), or a combination thereof.

Each processor of the image capture devices 102 and the image processing devices 116 is an electronic device configured of logic circuitry that responds to and executes instructions. The processor could comprise more than one distinct processing device, for example to handle different functions. The processor outputs results of an execution of the methods described herein. Alternatively, the processor could direct the output to a remote device (not shown) via a network.

FIGS. 1 and 1A illustrate various exemplary networks for performing the functionality described herein. It is to be appreciated that the networks 126, 128, 130 depicted in FIGS. 1 and 1A can include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as a storage medium. It is to be appreciated that the illustrated network connections of FIGS. 1 and 1A are exemplary and other means of establishing a communications link between multiple computers may be used.

In one example, image capture devices 102 allow a user to capture images at an event and send the images to the image processing devices. Image capture devices 102 and image processing devices may communicate over network 126 through one or more communications interfaces 134. Communications interfaces 134 may comprise either wired 136 or wireless 138 interfaces. It should be noted, however, that images may also be sent directly or indirectly to the image processing devices. For instance, the image may be sent directly to the image processing device 116 through one or more communication interfaces 140 without sending the image over a network. Exemplary communication interfaces 140 include a wired 142 connection between the image capture device 102 and the image processing device 116 or wirelessly 144 sending the image to the image processing device 116. Wireless 144 interfaces include, but are not limited to, Bluetooth, Near Field Communication (NFC), a wireless enabled memory card on the image capture device (e.g., Eye-Fi wireless SD card), etc. As another example of sending the image to the image processing device 116, an image may be sent to a cloud or file sharing site from which the image processing device 116 may retrieve the image. In another example, the image could be provided to the image processing device 116 through the use of storage media, such as a disc or a flash drive, and such a storage medium may be removed from the image capture device 102 and coupled to the image processing device 116.

With further reference to FIGS. 1 and 1A, system 100 includes one or more computing devices 148 to perform one or more computing steps of the system 100. One exemplary computing device 148 is illustrated, however, the system 100 is capable of having any number of computing devices 148 (including zero). Each computing device 148 may generally include at least one processor, at least one interface, and at least one memory device coupled via buses. Computing devices 148 may be capable of being coupled together, coupled to peripheral devices, and input/output devices. Computing devices 148 are represented in the drawings as standalone devices, but are not limited to such. Each computing device 148 may be coupled to other devices in a distributed processing environment.

With continued reference to FIGS. 1 and 1A, the image processing devices 116 may communicate with social networking sites such as, for example, Facebook, Twitter, Myspace, or any other social networking site, or any image sharing site such as, for example, Flickr, Shutterfly, Instagram, etc., via a network 128. It should be understood that while the majority of references included herein are made to social networking sites, reference of such social networking sites is intended to include any site adapted to include, handle, work with, or otherwise be associated with images including, for example, image sharing sites. The network 128 may be the same as networks 126, 130 or may be a different network. The description above pertaining to network 126 also applies to network 128 and, therefore, is not presented again herein. Social networking sites may be accessed via a large variety of network enabled electronic devices 152. Exemplary network enabled electronic devices 152 include, but are not limited to, a multifunction “smart phone” 154, a computing device, such as a tablet 156 or notebook 158 computer, etc. The description above pertaining to multifunction “smart phones”, computing devices, such as a tablets or notebook computers, etc., and their structure and functionality also apply to the network enabled electronic devices 152 described and illustrated herein and, therefore, such description is not presented again herein.

Referring now to FIG. 1A, a continuation of the system 100 is illustrated and, for clarity and simplicity, image processing devices 116 are re-illustrated in FIG. 1A. However, it is to be understood that the system 100 does not include two different sets of image processing devices. With particular reference now to FIG. 1A, the system 100 also includes at least one instance of a user communication device 162. Exemplary embodiments of user communication device 162 include, but are not limited to, multifunction “smart phone” 164 and a computing device, such as a tablet 166.

It should be understood that user communication devices 162 each generally include at least one processor, at least one interface, and at least one memory device coupled via buses. User communication devices 162 may be capable of being coupled together, coupled to peripheral devices, and input/output devices. It should further be noted that each user communication device 162 may include or be coupled to input devices, such as keyboards, speech recognition systems, mouses, trackballs, joysticks, etc. It is also understood that user communication devices 162 may include or be coupled to output devices, such as speakers, display devices and so forth to allow users to receive output of the processes described herein. Further, user communication devices 162 may be connected to various peripheral devices.

The user communication devices 162 all include memory and processors. The memory is a computer-readable medium encoded with a computer program. Memory stores data and instructions that are readable and executable by the processor of the respective device for controlling the operation of the processor. The memory may be implemented in a random access memory (RAM), volatile or non-volatile memory, solid state storage devices, magnetic devices, a hard drive, a read only memory (ROM), or a combination thereof.

Each processor of the user communication devices 162 is an electronic device configured of logic circuitry that responds to and executes instructions. The processor could comprise more than one distinct processing device, for example to handle different functions. The processor outputs results of an execution of the methods described herein. Alternatively, the processor could direct the output to a remote device (not shown) via a network.

FIG. 1A illustrates an exemplary network 130 for performing the functionality described herein. It is to be appreciated that the network 130 depicted in FIG. 1A can include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as a storage medium. It is to be appreciated that the illustrated network connections of FIG. 1A are exemplary and other means of establishing a communications link between multiple computers may be used. In one exemplary embodiment, the network 130 may be the same as networks 126, 128. In another exemplary embodiment, the network 130 may be different than networks 126, 128.

In one example, image processing devices 116 communicate with one or more user communication devices 162 over the network 130 in order to communicate a modified image (described in more detail below) to a user's communication device 162. Such communication over the network 130 may be achieved through one or more communications interfaces 134. Communications interfaces 134 may comprise either wired 136 or wireless 138 interfaces. It should be noted, however, that modified images may also be sent directly or indirectly to the user communication devices 162. For instance, the modified image may be sent directly to the user communication device 162 through one or more communication interfaces 140 without sending the modified image over a network. Exemplary communication interfaces 140 include a wired 142 connection between the image processing device 116 and the user communication device 162 or wirelessly 144 sending the modified image to the user communication device 162. Wireless interfaces include, but are not limited to, Bluetooth, Near Field Communication (NFC), a wireless enabled memory card on the image processing device (e.g., Eye-Fi wireless SD card), etc. As another example of sending the modified image to the user communication device 162, the modified image may be sent to a cloud or file sharing site from which the user communication device 162 may retrieve the modified image. In another example, the modified image may be provided to the user communication device 162 through the use of storage media, such as a disc or a flash drive, and such a storage medium may be removed from the image processing device 116 and coupled to the user communication device 162.

The user communication devices 162 are adapted to receive, display, and/or manipulate the modified images from the image processing devices. The user communication devices 162 include necessary software and hardware to perform these actions associated with the modified image. In some instances, at least a portion of the necessary software to perform these actions associated with the modified image may be associated with a software application or “APP” downloaded to or otherwise stored in the user communication devices 162.

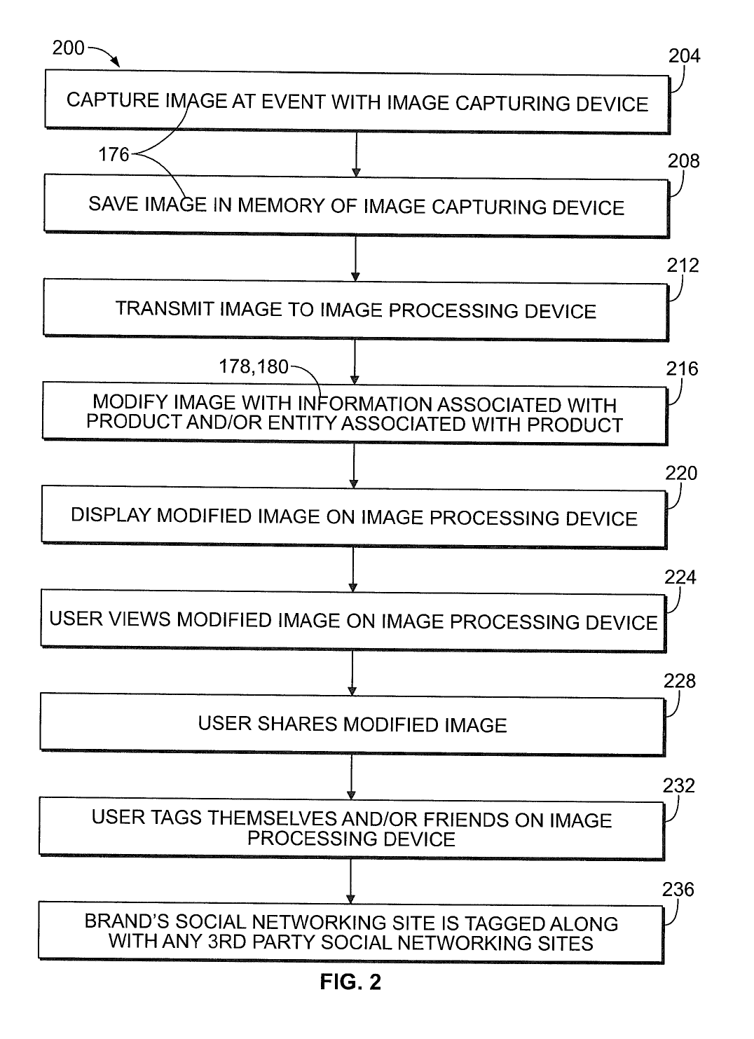

Referring now to FIG. 2, an exemplary flow diagram depicts an exemplary method 200 of the present invention. The exemplary method described herein and illustrated in the accompanying figure are not intended to be limiting upon the present invention. Rather, the present invention includes many other methods and processes, and equivalents and alternatives thereof, and all of which are intended to be within the spirit and scope of the present invention.

Events may be organized at venues in order to brand, advertise, or otherwise highlight or emphasize a particular product or products. The product emphasized at the event is produced by a first party, emphasized to a plurality of users (second party), and the event may be organized by a third party such as, for example, a promotion entity, advertising entity, on-line entity, or other entity capable of organizing such an event. The events may be organized at any venue and the events may emphasize any product. In one exemplary embodiment and with reference to the accompanying figures, an exemplary event is organized by a third party at a bar to emphasize an alcoholic product to a plurality of users at the bar and their friends not at the event. This exemplary embodiment is not intended to be limiting upon the present invention, but rather, the present invention may include many other embodiments of an event, product(s), venues, etc., and all of which are intended to be within the spirit and scope of the present invention.

Initially, a photographer is at the event and utilizes any type of image capture device 102. In some exemplary embodiments, the image capture device 102 may be a DSLR camera with a SD memory card or wireless-enabled memory card such as an Eye-Fi memory card. The photographer captures an image (e.g., a digital photo or video) at the event with the image capture device 102 (see step 204). In some instances, the captured image includes at least one person. In other instances, the captured image includes the emphasized product(s). In further instances, the captured image includes at least one person and the emphasized product(s). In the latter instance, the at least one person may be holding, consuming, or otherwise interacting with the emphasized product as arranged by the third party organizer of the event.

The captured image may be saved in the memory of the image capture device 102 (see step 208) and transmitted to the image processing device 116 (see step 212). The captured image may be transmitted to the image processing device 116 in a variety of different manners and all of such manners are intended to be within the intended spirit and scope of the present invention. In one exemplary embodiment, the image capture device 102 includes a wireless enabled memory card (e.g., an Eye-Fi wireless enabled SD card) which is in communication with a network 126 (e.g., a WLAN or any other type of network) along with the image processing device. The image capture device 102 communicates the captured image over the network 126 to the image processing device 116. The network 126 may be the venue's network accessible by customers of the venue or the network 126 may be created on a separate cellular device (e.g., 4G stick or phone). In another exemplary embodiment, the image capture device 102 includes a wireless 144 enabled memory card (e.g., an Eye-Fi wireless enabled SD card), which creates a “WiFi” hotspot and the image processing device 116 includes the appropriate software (e.g., a software application or “APP”) and hardware to communicate over the hotspot created by the wireless enabled memory card to receive the captured image. In further instances, a memory card on the image capture device may be manually removed there from and coupled to the image processing device 116. In still other examples, the image capture device 102 may be wired 142 to the image processing device 116 via, for example, a USB port and appropriate USB cable. In still further examples, the image capture device 102 may transmit the captured image to the image processing device 116 in other wireless 144 manners such as, for example, Bluetooth.

With continued reference to FIG. 2, the image processing device 116 is adapted to modify the captured image after receipt of the captured image from the image capture device 102 (see step 216). The image processing device 116 includes necessary software and hardware to perform any type of modification to the captured image including the exemplary image modification described herein and illustrated in the figures. In some instances, at least a portion of the necessary software to perform the image modification may be associated with a software application or “APP” downloaded to or otherwise stored on the image processing device 116.

In one exemplary embodiment, the image processing device 116 may modify the image 176 to include information 178 associated with the product emphasized at the event. The information 178 may be presented on the image in any form and at any location. For example, the information may include the name of the product, name of the company who produces the product, or any other information associated with the product. Additionally, the information 178 may be presented on the image 176 in any manner such as, for example, as a semi-transparent image of a logo overlaid on the original captured image, as a border at least partially surrounding or at least partially covering a periphery of the original captured image, or any other manner.

In another exemplary embodiment, the image processing device 116 may modify the image 176 to include information 180 associated with the third party organizing the event. The information 180 may be presented on the image 176 in any form and at any location. For example, the information 180 may include the name of the third party or any other information associated with the third party. Additionally, the information 180 may be presented on the image in any manner such as, for example, as a semi-transparent image of a logo overlaid on the original captured image, as a border at least partially surrounding or at least partially covering a periphery of the original captured image, or any other manner.

In still other exemplary embodiments, the image processing device 116 may modify the image 176 to include information 178, 180 related to both the product and the third party. In yet other embodiments, the image processing device 116 may modify the image 176 to include other information such as time of day, date, the name or type of event, etc.

The image processing device 116 may be preprogrammed by the third party to introduce the relevant information onto the captured image. Such preprogramming may occur prior to the event and the image processing device 116 may include the appropriate software and hardware to automatically modify the captured image to include the preprogrammed information upon receipt of the captured image from the image capture device 102. This automatic image modification may occur without any additional interaction from the third party from the time the image processing device 116 receives the captured image and the time the modified image 176 is displayed on the image processing device 116 (see step 220). For example, preprogrammed information may include name of the product, entity that produces the product, name of third party, name or type of event, etc. Additionally, in instances where date, time of day or other continuously or semi-continuously changing information is desired to be included on the image 176, the image processing device 116 determines the state of the changing or semi-changing information at the time of image modification and modifies the image 176 using the current state of the information.

With further reference to FIG. 2, after modification of the image 176, the image processing device 116 displays the modified image 176 thereon (see step 220). Since the image capture device 102 will be capturing multiple images throughout the event, the image processing device 116 may display a plurality of captured image simultaneously. In an exemplary embodiment, the displayed images do not include the modified information. However, it should be understood that the plurality of displayed images may alternatively include the modified information. At the event, a model or other person associated with any one or more of the producer of the product, venue, or third party may be carrying the image processing device 116 and showing the images displayed thereon to people at the venue and particularly those people in the captured image. The people or users at the venue view the displayed image(s) on the image processing device 116 (see step 224) and may select one or more images on the image processing device 116 to share with friends on a social networking site (see step 228).

After a user selects an image from the plurality of displayed images, the image processing devices 116 solely displays the selected modified image 176 in its modified form with the modified information. The user now has the ability to tag themselves and/or their friends also included in the modified image 176 (see step 232). The user selects the tag icon displayed on the image processing device 116, which then causes the image processing device 116 to display a log in screen for a social networking site. Since the present invention may be utilized with any social networking site, the image processing device 116 may display a log in screen for any social networking site. In an exemplary embodiment, the image processing device 116 may display a FACEBOOK log in screen. In other exemplary embodiments, the image processing device 116 may display a plurality of icons associated with a plurality of social networking sites. The user may select the icon associated with the desired social networking site and the image processing device 116 will display a log in screen associated with the selected social networking site. It should be understood that the log in step may occur at any time in the process and that the position in which the described and illustrated log in step is presented in the process is for exemplary purposes only and is not intended to be limiting upon the present invention.

The user logs into the social networking site and then continues the process of tagging themselves and/or their friends. The image processing device 116 displays identification information associated with the logged in user. The image processing device 116 also displays instructional information to assist the logged in user with tagging themselves and/or their friends. For example, the image processing device 116 instructs the user to tap a face of a person in the modified image to tag that person. The image processing device 116 displays a drop down list of individuals after tapping a person's face in the modified image 176. The user selects a person from the drop down list associated with the tapped face or types in the individual's name. The user tags, in this manner, as many individuals in the modified image as they desire. Additionally, the user may add a comment associated with the modified image 176 if desired prior to sharing on the social networking site. The image processing device 116 displays an icon for the user to select when finished tagging themselves and/or friends. Upon selection of the icon associated with tagging completion, the modified image 176 is shared on the social networking site, the user and/or their selected friends are tagged in the modified image 176, and the producer of the product and third party organizer are tagged in association with the modified image 176 as well (see step 236). In some instances, the producer of the product and the third party organizer are automatically tagged in every shared image. Additionally, the venue may be automatically tagged. These automatically tagged entities are preprogrammed into the image processing device 116 and may be altered depending on the event, the emphasized product, the venue, the third party organizer, etc. In other instances, a user in the modified image 176 may decide that they do not desire other entities to be tagged. Thus, the user may unselect the additionally tagged entities by, for example, touching the check boxes on the touch screen of the image processing device 116.

In other exemplary embodiments, the modified images may be tagged in a different manner. For example, a user may not tag themselves at the event and, instead, a model or other representative of the producer of the product or third party may acquire the necessary information from the user at the event to later contact the user via one or more social networking sites. The model or other representative may acquire the user's name and/or other information at the event, then subsequently (e.g., the next day, next week, or any other timeframe) search for the user on one or more social networking sites using the provided information. Once the appropriate user is identified on the one or more social networking sites, the third party or producer of the product contacts the user through the social networking site (e.g., sending a friend request on FACEBOOK, etc.). After the user accepts the friend request, the third party or producer of the product may tag the user on the modified image.

In some exemplary embodiments, a user has the ability to share the modified images with multiple social networking sites, which may occur in a variety of different manners. In one example, the user may log into multiple sites at the log in step described above prior to tagging individuals in the modified image 176. In such an instance, the user will share the modified image 176 with all the social network sites in which the user is logged into upon finalizing the tagging process and selecting to share the modified images 176. In another example, after completion of sharing the modified image 176 with a single social networking site in the exemplary manner described above, the image processing device 116 may display a screen including multiple icons associated with multiple additional social networking sites. The user may select as many of the additional social networking sites, log into those sites, and share the modified images 176 with the selected social network sites. As a further alternative, a user may share the modified images 176 via email. In such an instance, the image processing device 116 may display an icon associated with email, the user may select the email icon, and the user may enter as many email addresses as desired to which the modified image 176 will be sent.

After modified images 176 are shared to a social networking site, users and their friends may access the social networking site via their network enabled electronic devices 152 (see FIG. 1). The modified images 176 will be viewable by the friends of each user tagged in the modified image 176. Users of social networking sites often have hundreds or thousands of friends. All of these friends are able to see the images in which the user is tagged. At a single event, hundreds of people may decide to tag themselves and/or friends in modified images 176 resulting in all the friends of each one of the tagged individuals being able to see the modified images 176 including information associated with an emphasized product, brand, and the third party organizer This may result in thousands, tens-of-thousands, or more people being exposed to the information included on the modified image 176. This provides a valuable manner of branding and advertising products, entities producing the products, and/or the third party.

Referring now to FIG. 1A, modified images 176 may also be transmitted to the user's communication device 162 for viewing and manipulation on the user's communication device 162. As indicated above, the modified images 176 may be transmitted over a network 130 or more directly through a direct wire 142 or wireless 144 manner. The user may then do whatever they want with the modified image 176 such as, for example, further distribute the image 176 via email or other manners of distribution, thereby further extending the branding and/or advertising of the product and/or entities having information included on the modified image 176.

In some exemplary embodiments, modified images 176 may be stored in a memory location associated with the third party organizer of the event in addition to the modified images 176 being stored and associated with the social networking sites of the tagged individuals. By the third party retaining the modified images 176, the third party may distribute the modified images 176 in additional manners to that described above. For example, the third party may email a link associated with the stored modified images 176 to the email addresses of the users who utilized their service at a prior event. The users will then have additional access to the modified images 176, which may result in further distribution of the modified images 176. This may result in further branding and/or advertising of the product and/or entities having information included on the modified images 176.

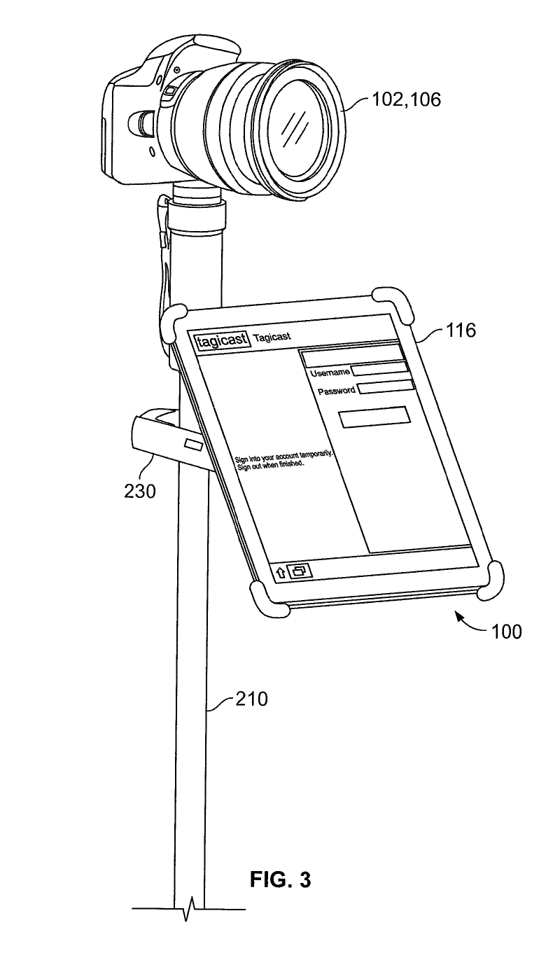

Turning now to FIG. 3, in another exemplary embodiment, system 100 comprises image capture device 102, elevation rod 210, image processing device 116, and stand 230, wherein image capture device 102 comprises camera 106. Camera 106 captures image 176 and communicates image 176 to image processing device 116 wirelessly. As noted above, it is also contemplated herein that camera 106 may communicate image 176 via a wire, via removing a memory card from camera 106 and placing the memory card in image processing device 116, or any of the mechanisms described above.

It is contemplated herein that the embodiment shown in FIG. 3 comprises camera 106 and tablet 110 connected to a stand, wherein images 176 captured by camera 106 are simultaneously communicated to tablet 110 even as camera 106 continued to capture images 176. For exemplary purposes only and without limitation, camera 106 may comprise a Nikon D90 or other similar cameras 106 that allow reading and writing at the same time.

In the exemplary embodiments of the system described above and illustrated in the accompanying figures, the system includes a separate image capture device and a separate image processing device. In other exemplary embodiments, the system may include a single device adapted to perform all the functionality of the image capture device and the image processing device. Exemplary devices that may perform all the functionality of the image capture device and the image processing device include, but are not limited to, a multifunction “smart phone” and a computing device, such as a tablet or notebook computer. The single device may be a user's device at the event or may be a device of the third party. In instances where the user's device is the single device, the user may have the necessary software application or “APP” downloaded to their device. Such downloaded application or “APP” along with the software and hardware of the user's device would be capable of performing all the functionality of the image capture device and the image processing device described above. A single device provided by the third party would also include the necessary software and hardware to perform all the same functionality. Additionally, in such exemplary embodiments, the single device may capture images, save images in its memory, modify images, display the modified images, allow a user to view and interact with the modified images, user can share the modified images via the single device, user can perform tagging on the single device, etc. One step not required in such embodiments is that the captured image does not require transmission from an image capture device to an image processing device because these two devices are combined into a single device, thereby requiring no transmission.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A computer-implemented method for image modification and sharing, the method comprising the steps of:
receiving an image taken at an event, wherein the image is received at an image processing device, the image processing device comprising a processor and memory where the image may be stored;
modifying the image with information associated with the event, wherein the information is associated with a product emphasized at the event; and
sharing the modified image.

2. The method of claim 1, wherein the step of modifying comprising overlaying a logo on the image.

3. The method of claim 2, wherein the overlaid logo is semi-transparent.

4. The method of claim 3, wherein the overlaid logo comprises a company name.

5. The method of claim 4, wherein the company name is associated with the product.

6. The method of claim 1, wherein the step of receiving the image comprises receiving the image from an image capturing device, and wherein the image capturing device creates its own wireless network over which the image is communicated to the image processing device.

7. The method of claim 1, wherein the step of sharing the modified image comprises sending the modified image to a user communication device.

8. The method of claim 7, wherein the step of sending the modified image to a user communication device comprises sending the modified image to a file sharing site from which the user communication device may retrieve the modified image.

9. The method of claim 1, wherein the image capturing device comprises a memory card, and wherein the step of receiving the image comprises removing a memory card from the image capturing device and connecting the memory card to the image processing device.

10. The method of claim 1, wherein the image comprises a plurality of images, and wherein the modified image comprises a plurality of modified images, further comprising the step of:
displaying the modified image; and
wherein the step of sharing the modified image comprises selecting one or more images to share.

11. The method of claim 10, wherein the selected images are modified, which creates selected modified images, which are shared.

12. The method of claim 1, the method further comprising the steps of:
logging in to a social networking site; and
tagging the modified image.

13. The method of claim 12, further comprising the steps of:
securing an image capturing device to an elevation rod; and
securing the image processing device to the elevation rod via a stand, wherein the step of receiving the image comprises receiving the image from the image capturing device,

14. A system to modify and share images, comprising:
a memory;
a processor disposed in communication with said memory, and configured to issue a plurality of instructions stored in the memory, wherein the instructions issue signals to:
receive an image taken at an event, wherein the image is received at an image processing device;
modify the image with information associated with the event;
display the modified image; and
sending the modified image to a user communication device.

15. The system as recited in claim 14, wherein the information includes a semi-transparent logo overlaid on the image.

16. The system as recited in claim 15, wherein the instructions further issue signals to:
login to a social networking site; and
tag the modified image, wherein tagging the modified image comprises selecting a person in the modified image and identifying the person on the social networking site.

17. The system as recited in claim 16, wherein sending the modified image to a user communication device comprises sending the modified image to a file sharing site from which the user communication device retrieves the modified image.

18. The system as recited in claim 16, wherein receiving the image comprises receiving the image without receiving the image over a network.

19. A non-transitory computer-readable storage medium and one or more computer programs embedded therein, the computer program comprising instructions, which when executed by a computer system cause the computer system to:
receive an image taken at an event, wherein the image is received at an image processing device;
modify the image with information associated with the event, wherein the modification includes adding semi-transparent labels;
display the modified image; and
share the modified image.

20. The non-transitory computer-readable storage medium of claim 19, wherein the image comprises a plurality of images, and wherein the modified image comprises a plurality of modified images, and wherein sharing the modified image comprises initially selecting one or more images to share, and wherein the selected images are modified, which creates selected modified images, which are shared.
